(19) United States
(12) Patent Application Publication
(10) Pub. No.: US 2005/0118369 A1
(43) Pub. Date: Jun. 2, 2005

(54) Structural sandwich plate members

(75) Inventor: Stephen John Kennedy, Ontario (CA)

Correspondence Address: Darby & Darby, 805 Third Avenue, New York, NY, 10022-7513, US

(73) Assignee: Intelligent Engineering (Bahamas) Limited, Nassau (BS)

(21) Appl. No.: 10/503,289

(22) PCT Filed: Jan. 17, 2003
(86) PCT No.: PCT/GB03/00225

(30) Foreign Application Priority Data
Jan. 28, 2002 (GB) 0201903.2

(51) Int. Cl. B32B 27/04; B32B 27/12; B32B 31/06

(52) U.S. Cl. 428/35.7; 428/297.4; 428/300.7; 428/339; 264/261

(57) ABSTRACT

A structural sandwich plate member, comprising first and second face plates and a plastics or polymer core bonding said face plates together with sufficient strength to transfer shear forces therebetween, said face plates being formed of a non-metal reinforced composite material.

### CROSS REFERENCE TO RELATED APPLICATION

This is a U.S. national phase application under 35 U.S.C. §371 of International Patent Application No. PCT/GB03/00225 filed Jan. 17, 2003, and claims the benefit of Great Britian Patent No. 0201903.2 filed Jan. 28, 2002 which is incorporated by reference herein. The International Application was published in English on Aug. 7, 2003 as WO 03/064154 A1 under PCT article 21(2).

### FIELD OF THE INVENTION

The present invention relates to structural sandwich plate members, which plate members comprise outer plates bonded together by a core layer of plastics or polymer material which transfers shear forces therebetween, and to structures formed by connecting together structural sandwich plate members.

### BACKGROUND INFORMATION

Structural sandwich plate members, known commercially as SPS™, are described in U.S. Pat. No. 5,778,813, British Patent Application GB-A-2 337 022 and International Application No. GB00/04198 which documents are incorporated herein by reference. Such structural sandwich plate members comprise outer metal plates bonded together by a plastics or polymer core with sufficient strength to transfer shear forces therebetween. The plastics or polymer core may be solid and continuous, occupying the entire volume between the outer metal plates, or may be interrupted by, e.g. foam, forms which leave continuous plastics or polymer connections between the outer metal plates. A principal use of these structural sandwich plate members is to replace stiffened steel structures, e.g. in maritime, offshore and civil engineering applications. In such applications, the structural sandwich plate members enable the elimination of some or all stiffening elements providing a simpler structure that is easier to construct and maintain. In particular, the amount of welding necessary is generally substantially reduced as compared to a conventional stiffened steel structure.

A further advantage of such structural sandwich plate members is that they can be prefabricated, either as individual plate members or as more complex modules to be assembled into the eventual structure. Pre-fabricated modules can be made under factory conditions to greater accuracy than traditional structures, can be assembled on site and further ease construction.

### SUMMARY OF THE INVENTION

Although such structural sandwich plate members have considerable technical and economic advantages over traditional stiffened steel structures, their weight is comparable to, or moderately less than that of traditional stiffened steel structures and a considerable amount of steel or metal is still present, which can be undesirable in some applications.

It is an aim of the present invention to provide alternative forms of structural sandwich plate members, preferably with lower weight than those made with all metal face plates and having other improved properties.

According to the present invention, there is provided a structural sandwich plate member, comprising first and second face plates and a plastics or polymer core bonding said face plates together with sufficient strength to transfer shear forces therebetween, at least one of said face plates being formed of a non-metal reinforced composite or reinforced polymer material.

A structural sandwich member with one non-metal face plate can provide improved chemical resistance and is advantageous for use in forming storage tanks, with the non-metal face plate on the inside. If both face plates are made of non-metal material, a metal free structure, having reduced electromagnetic signature can be made.

The non-metal face plates are preferably made of a fiber-reinforced polymer material such as carbon-fiber reinforced polymer material. The strengths and like properties of such composite materials are often specified as a ratio whereby the value of the property in other units is divided by the density of the material. In the invention, the strength ratio of the face plates (tensile strength/density) is preferably in the range of from 0.03 to 0.5, most preferably 0.1 to 0.25 (MPa/kgm⁻³). Similarly, the stiffness ratio (modulus of elasticity/density) is preferably in the range of 0.5 to 50, most preferably 2 to 26 (MPa/kgm⁻³).

The structural sandwich plate members according to the invention are particularly advantageous for use in applications where extremely low weight is required or steel and other metals are undesirable. For example, the structural sandwich plate members according to the invention may be used in mine sweepers and other specialist military vessels for which a low electromagnetic signature or a reduction in ship/structure borne noise is desirable. Civil engineering applications for the invention include bridge deck panels and chemical tanks. For bridge deck panels, the weight savings can provide a substantial reduction in the cost of the superstructure supporting the deck and the non-metal face plates provide a structure that is resistant to corrosive road salts. For chemical storage tanks, one or both face plates can be made of a material chosen to resist chemical attack from the stored chemical.

The present invention also provides structures comprising at least one structural sandwich plate member as described above.

Further, the present invention provides a method of manufacturing a component of a structure comprising the steps of:
providing first and second face plates in a spaced apart relationship to define a cavity, at least one of said first and second face plates being formed of a non-metal reinforced composite material and
injecting plastics or polymer material into said cavity to bond said first and second face plates together with sufficient strength to transfer shear forces therebetween.

Yet further, the present invention provides a method of reinforcing an existing metal structure comprising the steps of:
providing a reinforcing layer on said metal structure in spaced apart relation to thereby form at least one cavity between inner surfaces of said metal structure and said reinforcing layer;
injecting an intermediate layer comprised of an uncured plastics or polymer material into said cavity; and
curing said plastics material so that it adheres to said inner surfaces of said metal structure and said reinforcing layer; wherein
said reinforcing metal layer is formed of a non-metal reinforced composite or reinforced polymer material.

This method can be used for the repair or rehabilitation of an existing metal, e.g steel, structure that has deteriorated due to age, corrosion or wear. The reinforcing layer reinstates the structural capacity of the existing structure and inhibits further deterioration. The light weight reinforcing layer may be shaped or formed off-site or in-side to fit the shape of the existing structure, including any reinforcing elements. The reinforcing layer may be made of, or include, a layer of ceramic material to provide enhanced fire resistance. The method of the present invention can be applied simply in confined or dangerous areas, e.g. the interior of storage tanks, using prefabricated sections to avoid hot work on site.

### BRIEF DESCRIPTION OF THE DRAWINGS

The present invention will be further described below with reference to the following description of exemplary embodiments and the accompanying drawings, in which:

FIG. 1 is a cross-sectional view of a structural sandwich plate member according to a first embodiment of the present invention;

FIG. 2 is cross-sectional view of a structural sandwich plate member according to a second embodiment of the present invention;

FIG. 3 is a cross-sectional view illustrating a method of joining two structural sandwich plate members according to the invention; and

FIG. 4 is a cross-sectional view of a structural sandwich plate member according to a third embodiment of the invention;

FIG. 5 is a partly sectional perspective view of a structure reinforced using a method according to a fourth embodiment;

FIG. 6 is a cross-sectional view of the structure of FIG. 5;

FIG. 7 is a cross-sectional view of the structure of FIG. 6 along line A-A.

In the drawings, like parts are indicated by like references.

### DETAILED DESCRIPTION OF THE DRAWINGS

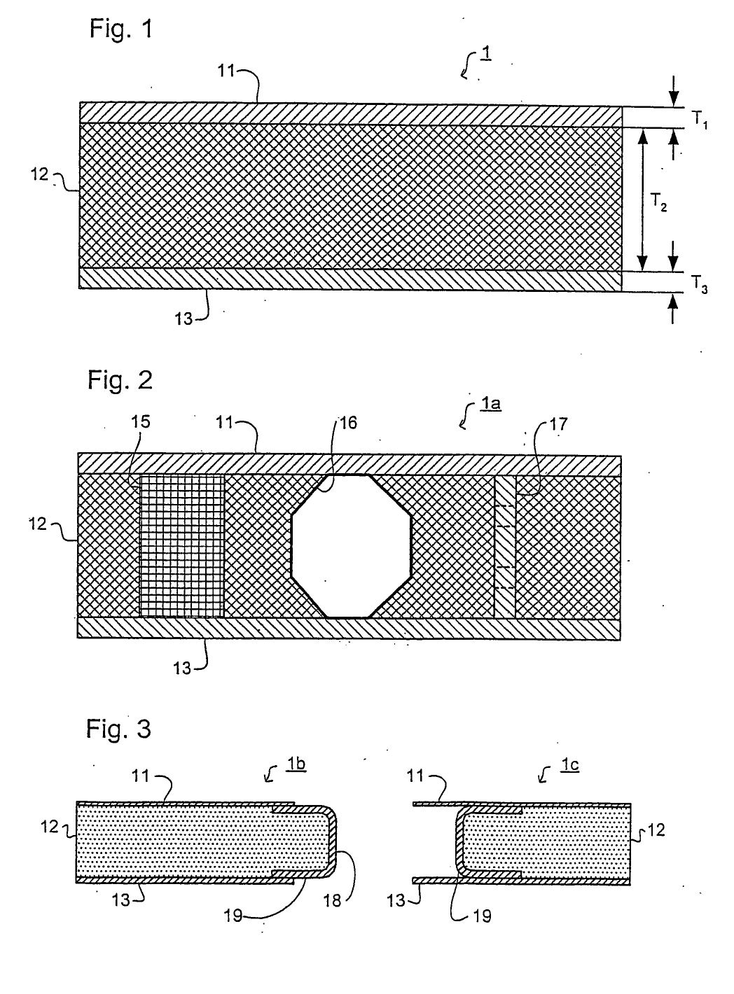

FIG. 1 shows in cross-section a structural sandwich plate member 1 according to a first embodiment of the present invention.

The structural sandwich plate member 1 comprises outer face plates 11 and 13 which are bonded together by core 12. The face plates 11, 13 are made of a carbon-fiber reinforced plastics material whilst the core 12 is made of a plastics or polymer material such as polyurethane. The core 12 is preferably compact, i.e. not foamed, though a certain amount of cavitation may be permitted in some applications. The core 12 is integrally bonded to the face plates 11, 13 providing continuous support and sufficient shear and bond strength to transmit the expected shear loads between them. The thicknesses of the sandwich elements 11, 12, 13 are selected to provide the flexural and in-plane strength and stiffness of the sandwich plate for the particular static and dynamic requirements The strength and stiffness ratios for the non-metal reinforced composite plates are expressed as the ratio of the tensile strength divided by the mass density; and the ratio of the modulus of elasticity divided by the mass density and are in the range of 0.03 to 0.95, preferably 0.1 to 0.25 (MPa/kgm⁻³); and 0.5 to 50, preferably 2 to 26 (MPa/kgm⁻³) respectively, for use in maritime, offshore and civil engineering structures. It will be appreciated that the dimensions of the member will vary according to application but for practical maritime and civil engineering applications the face plates may have thicknesses T₁, T₃ in the range of from 1 to 30 mm and the core a thickness T₂ in the range of from 10 mm to 150 mm. The thicknesses of the two face plates may be different and may vary across their area. Similarly, the thickness of the core may vary across the area of the plate member. Although the plate member 1 is shown in FIG. 1 as being flat it may be curved or have a more complex contour as desired for a specific application.

In a second embodiment of the invention, a structural sandwich plate member 1a shown in cross section in FIG. 2 may be provided with additional elements embedded in the core 12 to reduce weight or increase strength. Otherwise, the structural sandwich plate member of the second embodiment is the same as that of the first embodiment. For example, FIG. 2 shows a solid foam form 15 which has a lower density than the material of the core 12 and so reduces weight of the structural sandwich plate member. Alternatively, hollow form 16 may be used for the same purpose; such forms may comprise elongate extruded plastics pipes or prefabricated hollow foam forms and may have other profiles than as illustrated in FIG. 2. The hollow form 16 may be manufactured as a wide raft or in sections that connect together to form such rafts. The foam forms 15 and hollow forms 16 are positioned within the core so that continuous paths of the core material 12 connect the face plates 11, 13 together. Preferably, the foam or hollow forms 15, 16 leave continuous elastomer ribs extending between the face plates 11, 13. Solid or hollow foam or hollow forms may be layered, aligned, placed orthogonally or at any preferred orientation with respect to one another to maximize structural performance.

To increase the strength of the element, transverse shear plates 17 extending between the face plates 11, 13 may also be provided. Such shear plates are preferably perforated to improve bonding between the core 12 and the shear plates 17. The shear plates 17 assist in transfer of shear forces between face plates 11, 13.

To manufacture the structural sandwich plate member according to the invention, the face plates 11, 13 are placed in a spaced apart relationship, either in a mold or with edge members (not shown) spanning between them, to form a closed cavity. The cavity is then injected with material to form the core 12. Of course, internal elements such as those shown in FIG. 2 are placed in the mold prior to closing or on one of the face plates before the edge members are attached to form the closed cavity. The core material when setting acts to bond together the face plates to form a composite structural unit. The required bond is preferably formed through the natural adhesiveness between the core material and the face plates 11, 13 but, if desired, additional adhesives or surface preparations of the face plates 11, 13 or internal (wire) mesh placed parallel to the interior plate surfaces may be employed.

As shown in FIG. 3, to form complex structures, structural sandwich plate members 1b, 1c may be joined by providing a prefabricated edge member 19 on one structural sandwich plate member 16 that projects and a similar edge member 19 on the other that is recessed so that the two structural sandwich plate members interlock. A layer of suitable adhesive 18 is provided between the mating parts.

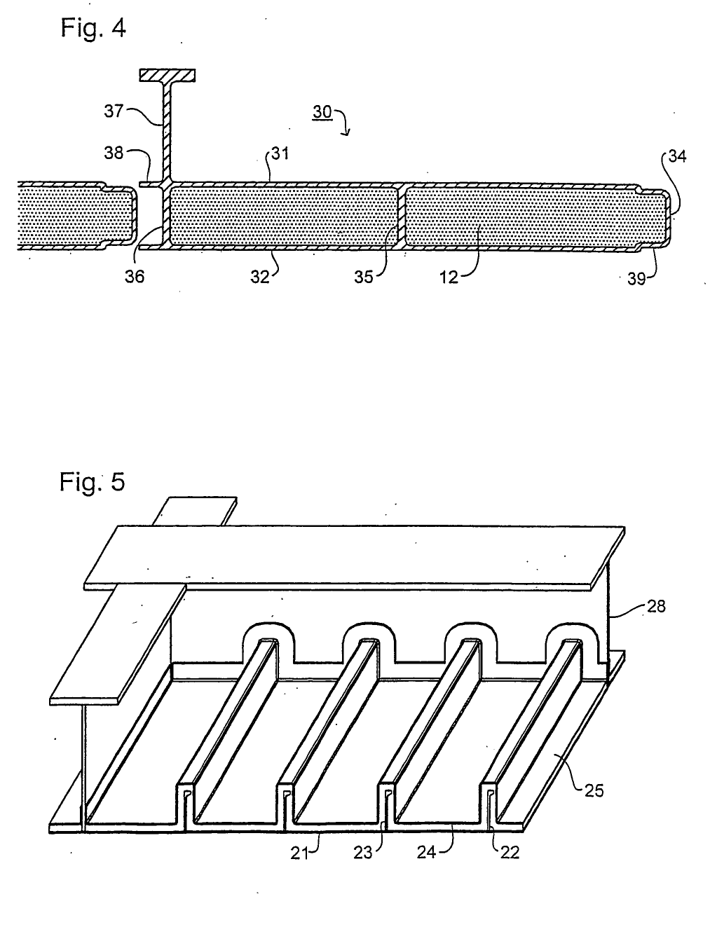

FIG. 4 shows a structural sandwich plate member 30 according to a third embodiment of the invention. In this embodiment, the complete outer shell is pultruded as an integral form, including additional details.

As seen in FIG. 4, the outer shell of the structural sandwich plate member 30 comprises face plates 31, 32, end walls 34, 36 and an internal stiffening rib 35. Aligned with end wall 36, an external stiffening girder 37 is provided. To facilitate connections between members 30, one end has a portion of reduced thickness 39 forming a male member that mates with a socket defined by flanges 38 on the other end. To complete the bond, adhesive is provided in the mating surfaces.

The members 30 are prefabricated off-site in long lengths, then cut as necessary and shipped to the construction site. On-site they are assembled into the desired structure, which may involve further trimming, and once in place, plastics or polymer is injected to form the core 12. In this way, dimensional accuracy can be assured by off-site manufacture and handling is facilitated on-site because the members are very light and easy to cut before the core 12 is injected. When the core is injected, the members achieve full structural strength.

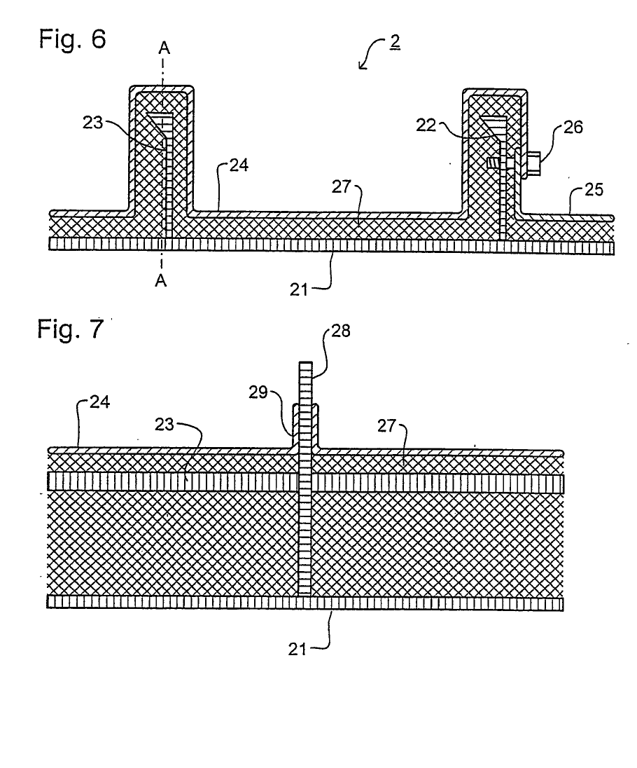

FIGS. 5, 6, and 7 show a fourth embodiment of the present invention in which overlay 2 is added to repair an existing metal structure.

In FIGS. 5, 6 and 7, the bottom plate of a transfer or storage tanker is shown at 21 and is reinforced by bulb flats 22, 23 and girders 28. Such bottom plates often become pitted overtime, necessitating repair or replacement. This has conventionally been done by cutting out the corroded plate section or reinforcement and welding in a replacement or adding additional plating over the corroded part. Where the tank or tanker has been used to store inflammable products, it is essential to flush out all residual vapours from the compartment in which such hot work is to be done, and also all neighbouring compartments. This is time consuming and expensive.

According to the invention, a reinforcing layer 24, 25 is positioned in a spaced apart relationship to the plate to be repaired, in this case bottom plate 21. Spaces, such as elastomer stubs, may be used to ensure the desired spacing. The reinforcing layer is made of a reinforced composite or reinforced polymer material as in the previous embodiments. It may be provided in prefabricated sections of standard forms, or continual sections for a specific job, which are fitted around the reinforcing elements 22, 23, 28. In the present example, the bulb flats 22, 23, are enclosed by the reinforcing layer but the girders 28 project through, Sections 24, 25 of the reinforcing layer make rolled lap joints to the girder 28. Where necessary, the sections can be cut to size with a jig-saw and can be joined by suitable adhesive or by bolting 26 to a bulb flat.

Once the reinforcing layer 24, 25 has been completed, plastics or polymer material is injected into the casing between reinforcing layer 24, 25 and plate 21 and cured to form core layer 27. The core layer 27 bonds the reinforcing layer and plate 21 together with sufficient strength to transfer shear forces expected in use and thus forms a composite structural whole.

With this invention, no significant heat is generated during the repair process so that only the compartment being worked in, and not neighbouring compartments, needs to be flushed of flammable vapours.

The method can also be applied to pipelines using molded or pultruded overlay sections with snap interlocking longitudinal seams and prefabricated ring perimeter sections.

Whilst embodiments of the present invention and possible uses for them have been described, it will be appreciated that the connecting member of the present invention may be constructed differently than as described and may be used in other ways, as will occur to the skilled reader. The present invention is not to be limited save within the scope of the appended claims.

1-21. (canceled)

22. A structural sandwich plate member, comprising first and second face plates and a plastics or polymer core bonding said face plates together with sufficient strength to transfer shear forces therebetween, at least one of said face plates being formed of a non-metal reinforced composite or reinforced polymer material.

23. A member according to claim 22 wherein said reinforced composite material is a fiber-reinforced polymer material

24. A member according to claim 23 wherein said polymer material is reinforced with carbon fiber.

25. A member according to claim 22 wherein said face plates have strength ratios in the range of from 0.03 to 0.5, preferably 0.1 to 0.25 (MPa/kgm⁻³).

26. A member according to claim 22 wherein said face places have stiffness ratios in the range of from 0.5 to 50, preferably 2 to 26 (MPa/kgm⁻³).

27. A member according to claim 22 wherein said core is formed of thermosetting material, such as a polyurethane material.

28. A member according to claim 22 wherein said core is compact.

29. A member according to claim 22 wherein said face plates have a thickness in the range of from 1 mm to 30 mm.

30. A member according to claim 22 wherein said core has a thickness in the range of from 10 mm to 150 mm.

31. A member according to claim 22 wherein said face plates and side walls spanning between said face plates are pultruded as a single unit.

32. A maritime structure, ship, or boat having a hull constructed from at least one structural sandwich plate member according to claim 22.

33. A bridge deck panel comprising at least one structural sandwich plate member according to claim 22.

34. A storage tank comprising at least one structural sandwich plate member according to claim 22.

35. A method of manufacturing a component of a structure comprising the steps of:
providing first and second face plates in a spaced apart relationship to define a cavity, said first and second face plates being formed of a non-metal reinforced composite material; and
injecting plastics or polymer material into said cavity to bond said first and second face plates together with sufficient strength to transfer shear forces therebetween.

36. A method of building a structure comprising the steps of:
manufacturing a plurality of structural components according to the method of claim 35; and
assembling said structural components to form said structure.

37. A method according to claim 36 wherein said steps of manufacturing and assembling are carried out at different sites.

38. A method of reinforcing an existing metal structure comprising the steps of:
providing a reinforcing layer on said metal structure in spaced apart relation to thereby form at least one cavity between inner surfaces of said metal structure and said reinforcing layer;
injecting an intermediate layer comprised of an uncured plastics or polymer material into said at least one cavity; and
curing said plastics material so that it adheres to said inner surfaces of said metal structure and said reinforcing layer; wherein
said reinforcing layer is formed of a non-metal reinforced composite or reinforced polymer material.

39. A method according to claim 38 wherein said existing metal structure is a metal panel that is supported by beams, girders, or bulb flats and said reinforcing layer is arranged such that at least some of said beams, girders, or bulb flats are positioned between said metal panel and said reinforcing layer.

40. A method according to claim 39 wherein said reinforcing layer is bent such that said reinforcing layer is further from said metal panel in the proximity of said beams or bulb flats than in other positions.

41. A method according to claim 38 wherein said existing metal structure is a metal panel reinforced by at least one girder, wherein said reinforcing layer is provided so that an edge thereof is jointed to said girder by a rolled lap joint.

42. A method according to claim 35 wherein said structure is a building, a bridge, a ship, a ship component, or an off-shore structure.

43. A method according to claim 38 wherein said structure is a building, a bridge, a ship, a ship component, or an off-shore structure.
